(19) United States
(12) Patent Application Publication
(10) Pub. No.: US 2016/0107642 A1
(43) Pub. Date: Apr. 21, 2016

(54) COLLISION AVOIDANCE SYSTEM USING DRIVER EYE MONITORING DURING GEAR CHANGE

(71) Applicant: CONTINENTAL AUTOMOTIVE SYSTEMS, INC., Auburn Hills, MI (US)

(72) Inventors: Jose C. Salgado, Glendale Heights, IL (US); Keyur Shah, Des Plaines, IL (US)

(73) Assignee: CONTINENTAL AUTOMOTIVE SYSTEMS, INC., Auburn Hills, MI (US)

(21) Appl. No.: 14/515,160

(22) Filed: Oct. 15, 2014

(51) Int. Cl. B60W 30/08

(52) U.S. Cl. CPC B60W 30/08

(57) ABSTRACT

A collision avoidance system is provided which includes a sensory system to determine a driver's intended forward or reverse travel direction by determination of a driver's head and eye position. A controller is provided that is cognizant of a driver's recent transmission gear shift to a forward or rearward direction. The controller prevents movement of the vehicle upon a conflict with the driver's intended travel direction and recent driver's gear shift.

### FIELD OF THE INVENTION

The present invention relates to collision avoidance systems for automotive vehicles.

### BACKGROUND OF THE INVENTION

In the chronicles of automotive vehicle accidents, there are many instances of accidents occurring due to unintended direction of vehicle movement. Often, vehicle operators make a mistake in the gear shift direction that they intend to travel in. The mistake is often made during the initial operation of the vehicle. A vehicle operator can often be intending to go in reverse, but inadvertently place the vehicle in a forward drive gear. In other instances, a vehicle operator may desire for a car to go forward, but inadvertently place the car in the reverse gear. Inadvertent gear selection is further enhanced by placement of the gear selector on the vehicle floor instead of from the vehicle steering column. Often when the gear selector is on the floor, the vehicle operator does not look down to confirm that the proper gear has been selected, but rather relies upon their tactile touch memory to assure that the right gear has been selected. Upon taking their foot off of the brake after making the gear selection, the driver can often experience undesired movement in a non-intended direction. Such incidents can be further multiplied by the unfortunate habit of some drivers to be distracted by cellular phones or other electronic devices when starting to drive a vehicle. It is desirable to provide a collision avoidance system which can inhibit, if not totally eliminate undesired movement of a vehicle when the vehicle operator has mistakenly selected the wrong gear.

### SUMMARY OF THE INVENTION

To make manifest the above noted and other manifold desires, a revelation of the present invention is brought forth. In a preferred embodiment, the present invention brings forth a collision avoidance system and method of utilization thereof for an automotive vehicle. The system has a sensory system to determine a driver's intended forward or reverse travel direction by a determination of the driver's head and eye position. A controller is provided that is cognizant of a driver's recent transmission gear shift to a forward or rearward direction. The controller prevents movement of the vehicle upon a conflict with the driver's intended travel direction and recent driver's gear shift.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view from the interior of an automotive vehicle looking forward illustrating various visual zones;

FIG. 2 is a perspective view of an interior of an automotive vehicle when the driver looks in the rearward direction;

FIG. 3 is side sectional view of an automotive vehicle interior illustrating a position of a driver and a sensory system utilized in the crash avoidance system of the present invention;

FIG. 4 is a driver's face view as picked up by the sensory system with the driver looking straight ahead;

FIG. 5 is a driver's face view showing the driver's head turned to look at a rearview mirror or to look rearward;

FIG. 6 is a driver's face view looking in a forward position, but toward an interior rearview mirror;

FIG. 7 is a picture of a driver's head when the driver is looking at the exterior driver's side rearview mirror; and

FIG. 8 is a driver's face view wherein the driver is wearing darkened glasses.

### DETAILED DESCRIPTION OF THE PREFERRED EMBODIMENTS

The following description of the preferred embodiment(s) is merely exemplary in nature and is in no way intended to limit the invention, its application, or uses.

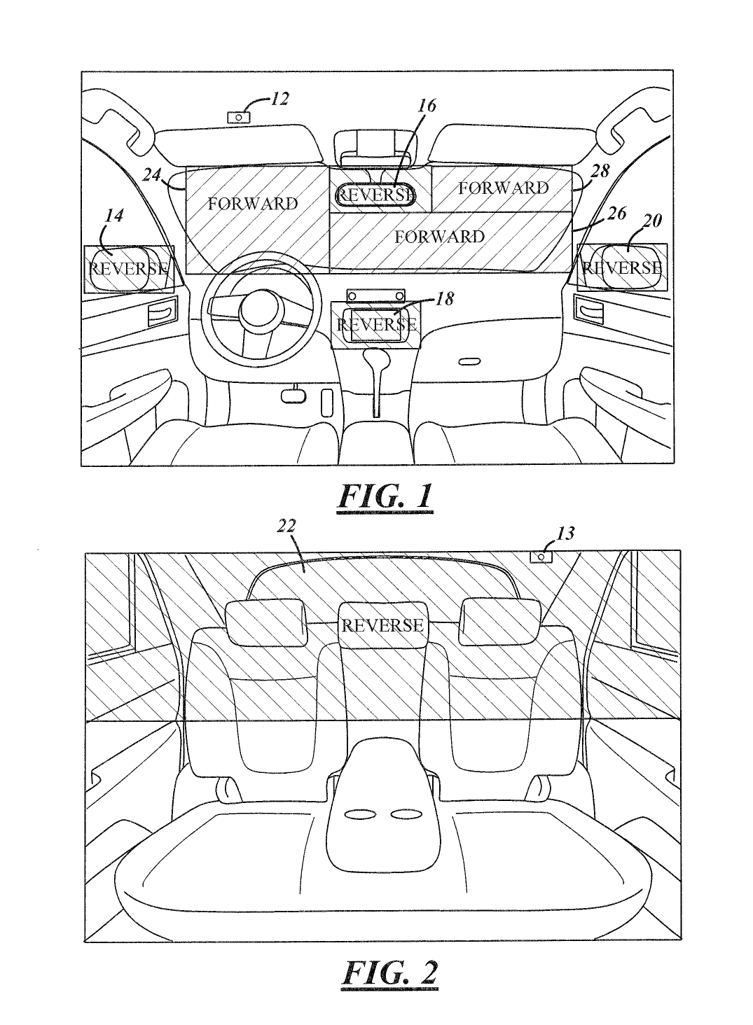

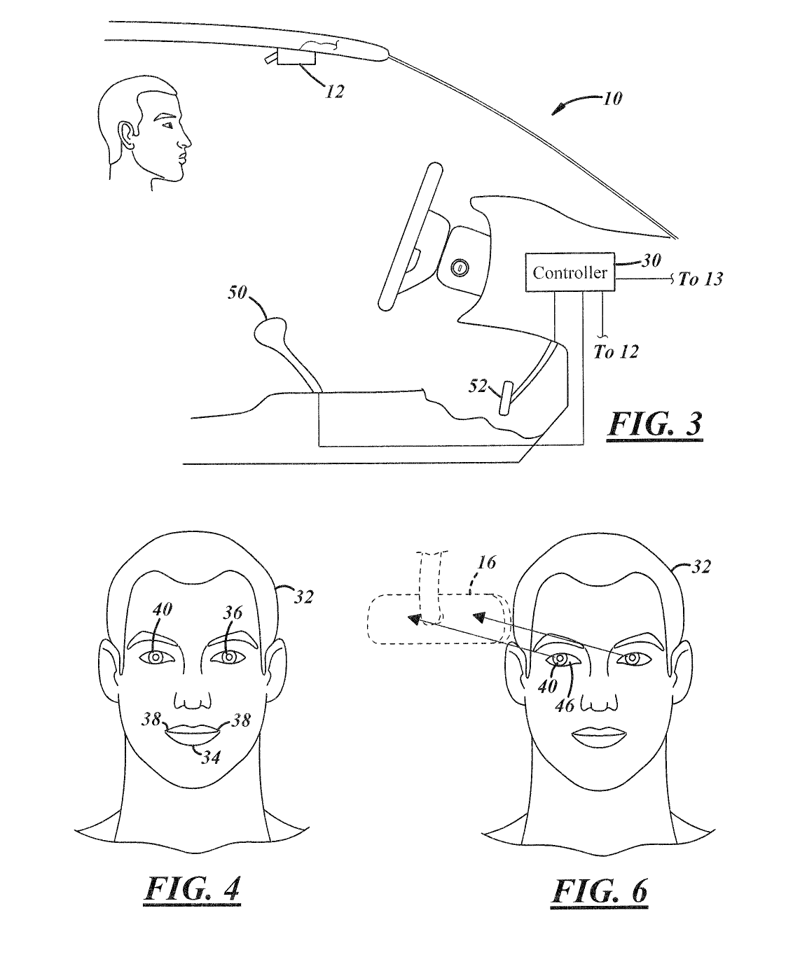

Referring to FIGS. 1-8, a collision avoidance system for an automotive vehicle is provided. The collision avoidance system includes a sensory system which is typically a visual camera. As shown, there is a single camera 12 in the front and a second camera 13 in the rear; however, in other embodiments, there can be additional cameras located in various locations in the automotive vehicle 10. The sensory system is utilized to determine a driver's intended forward or rearward by determining a driver's head position. In the rear direction, there are several items in various viewing zones. The driver's side rearview mirror 14 provides a rear viewing zone. Another rearward viewing zone is provided by the interior rearview mirror 16. A lower rear viewing zone is brought about by a rearview camera display 18. Another rear view zone is brought about by the passenger side exterior mirror 20. FIG. 2 reveals rearward area reverse viewing zone 22.

Looking forward, there are three main viewing zones. Viewing zone 24 is straight ahead of the vehicle steering wheel. Looking forward underneath the interior rearview mirror 16 and slightly to the right before exterior rearview mirror 20 is a forward viewing zone 26. Above the front viewing zone 26 and to the right of the interior rearview mirror 16 is a forward viewing zone 28.

As mentioned previously, the sensory system often will have a visual camera or cameras. The cameras are connected with a processor provided within a controller 30. The sensory system first identifies the face of the driver's head 32. The sensory system (which provides real time feedback to the processor) secondly identifies key features of the driver's face, such as the lips 34 and the eyes 36. The sensory system first attempts to find the edges 38 of the lips. The sensory system identifies the eyes 36 by finding two dark spots 40 which are the pupils of the eyes. The sensory system assumes that the eyes are generally above the edges 38 of the lips and parallel to the lip edges. After identification of the pupils 40, the sensory system then seeks to identify the surrounding color of the pupil. If the surrounding color is white or light yellow, the sensory system evaluates that there is a high probability of there being the human eye and will accept the two pupils 40 as the eyes 36. For simplicity, if the edges of the lips 38 or the eyes 36 not be identified, it is assumed that the driver 32 is not looking forward. The sensory system allows blinking of the eyes 36, but prolonged eye closure is identified as not looking in the forward or reverse direction upon gear changes. In such cases, the driver intended direction is indeterminate and the controller 30 will not allow movement of the vehicle. Whenever the controller 30 through the collision avoidance system 7 does not allow movement of the vehicle, a visual and/or audio signal is be provided to allow the vehicle operator to be informed that the collision avoidance system has been engaged. An override switch is provided to all the vehicle operator to disable the collision avoidance system.

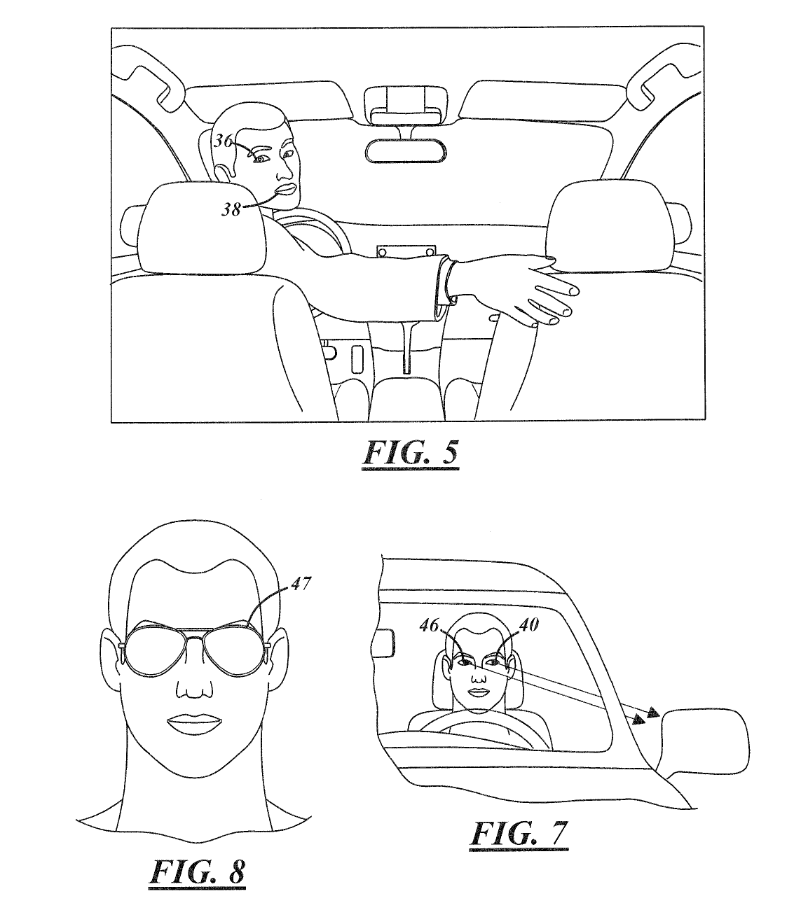

The controller 30 is preprogrammed to know the location of the various viewing zones. In FIG. 5, the vehicle operator has turned their head to the right or is looking rearward and the collision avoidance system 7 picks up only one edge 38 of the lips and only at maximum, one eye 36 (by camera 12). The system 7 interprets this as that the driver is either looking at the passenger side rearview mirror or is looking rearward (confirmation is given by rear camera 13). Referring back to FIG. 4 is an example wherein the driver is looking in a forward viewing zone and the collision avoidance system determines that the driver is intending to travel forward. As shown in FIG. 6, the driver's head is rotated in a forward direction; however, the system 7 determines the orientation of the driver's pupil 40 with respect to the sclera 46 of the driver's eye to determine that the driver eye focus is looking at the interior rearview mirror 16. FIG. 7 illustrates an example wherein the driver's head is forward but is looking toward the exterior driver's side rearview mirror 14 by virtue of the position of the pupils 40 with the sclera 46.

In operation, sensory system 12 begins operation as soon as the vehicle turns on or as soon as the driver presses on the brake pedal 52. When the driver shifts the gear lever 50 into gear, the controller is made cognizant of the gear shift. Through the data given by the sensory system 12, the controller determines if the driver intendeds a forward or reverse travel direction by determination of the driver's head and eye position as previously mentioned. If there is a conflict between the driver's intended direction and the most recent driver's transmission gear shift in the forward or rearward direction, the controller 30 prevents movement of the vehicle. If the driver's head position is indeterminate, the controller 30 prevents movement of the vehicle. Upon the controller prevention of movement of the vehicle, an alarm will be set off. The alarm can be on various displays or can be an audio signal. The controller can also be programmed to only prevent motion as a driver removes their foot from the brake.

When the driver has on dark sunglasses 47 as shown in FIG. 8, the collision avoidance system will make an attempt to find the face's lip and eyes. If unable to find the eyes, the collision avoidance system will notify the driver that it is disabled due to an obstacle.

The description of the invention is merely exemplary in nature and, thus, variations that do not depart from the gist of the invention are intended to be within the scope of the invention. Such variations are not to be regarded as a departure from the spirit and scope of the invention.

1. A collision avoidance system for an automotive vehicle, the collision avoidance system comprising:
a visual sensory system the visual sensory system being located inside and coupled to the automotive vehicle, the visual sensory system comprising:
a first camera located in front of a driver of the automotive vehicle and which is directed toward a driver of the automotive vehicle;
a second camera located behind the driver and which is also directed toward the driver; and
a controller coupled to both the first and second cameras;
wherein the first and second cameras and the controller are configured to determine the driver's intended forward or reverse travel direction by determining the driver's head position and the driver's eye position, the driver's head and eye positions being determined by one of the first camera and the second cameras detecting edges of the driver's lips and detecting the driver's eyes; and
the controller being additionally configured to detect whether a transmission gear shift is positioned in either a forward or rearward direction, said controller preventing movement of said vehicle upon a conflict with a determined intended travel direction and the position of said driver gear shift.

2. The collision avoidance system of claim 1 wherein the first and second cameras are also directed toward each other and wherein the controller is additionally configured to determine that said driver's intended travel direction is rearward by determining that the driver is viewing at least one of a group of items including an interior rearview mirror, an exterior driver's side rearview mirror, an exterior passenger side rearview mirror, a rearview camera display, or an area rearward of said vehicle.

3. The collision avoidance system of claim 1 wherein said visional sensory system is additionally configured to determine a driver's intended forward travel direction by determining said driver's head and eyes are facing a windshield in a region other than an interior rearview mirror.

4. The collision avoidance system of claim 1 wherein said controller is additionally configured to prevent movement of said vehicle if said driver head position is in an indeterminate position that does not indicate either a forward or rearward direction.

5. The collision avoidance system of claim 1 wherein said system is configured to provide a signal taken from a group of audio signal or display signals, when said controller has determined a conflict with driver intended travel direction and a position of said gear shift.

6. The collision avoidance system of claim 1 wherein said controller is configured to not prevent movement of said vehicle until said driver disengages a brake for said vehicle.

7. The collision avoidance system of claim 1 wherein said controller is additionally configured to determine a driver's head position by a relationship between the driver's eyes' pupils and sclera and to determine the driver's intended forward or reverse travel direction.

8. A collision avoidance system for an automotive vehicle, the collision avoidance system comprising:
a visual sensory system located inside the automotive vehicle and being operatively coupled to the automotive vehicle, the visual sensory system comprising:
a first camera located in front of a driver of the automotive vehicle and directed toward the driver of the automotive vehicle;
a second camera located behind the driver and which is also directed toward the driver, both cameras being directed generally toward each other; and
a controller coupled to both the first and second cameras;
wherein the cameras and controller are configured to determine a driver's intended forward or reverse travel direction by determining the driver's head position and the driver's eye position and additionally configured to determine said driver's eye focus by determining a position of said driver's eye pupil with respect to the driver's eye's sclera, wherein the driver's eye focus into a driver side exterior rearview mirror, interior rearview mirror, passenger side exterior rearview mirror, rearview camera display, or a turn of driver's head to look backwards, is determined by the controller to be indicative of the driver's intent to move in the reverse travel direction, and wherein the driver's focus into the windshield other than in a region about the interior rearview mirror is determined by the controller to be indicative of the driver's intention to travel in a forward direction;
the controller being additionally configured to determine whether a transmission gear shift is positioned to make the vehicle go in either a forward or rearward direction, said controller being configured to prevent movement of said vehicle upon the detection of a conflict with said driver intended travel direction and a position of said gear shift. upon the driver's release of a brake for the automotive vehicle.

9. The collision avoidance system of claim 8 wherein said collision avoidance system provides a signal taken from a group of audio or display signals when said controller has determined a conflict with driver intended travel direction and said gear shift position.

10. A method of avoiding collisions in automotive vehicles, the method comprising:
determining a driver's head position and the driver's eye position by detecting edges of the driver's lips and detecting the driver's eyes, the detection of the driver's lips and eyes being made by either a first camera that is located in front of the driver or by a second camera that is located behind the driver, both cameras being directed toward the driver and toward each other;
determining a driver's intention to travel in either a forward or reverse direction by the determined head and eye positions; and
providing the determination of the driver's head and eye positions to a controller that is coupled to a transmission gear shift having forward and rearward travel direction positions, said controller configured to prevent movement of said vehicle upon a conflict with said driver's intended travel direction and the travel direction position of said gear shift.

11. The method of avoiding collisions of claim 10 further including determining driver's intended travel direction is rearward by determining that the driver is viewing at least one of a group of visual zones including an interior rearview mirror, an exterior driver's side rearview mirror, an exterior passenger side rearview mirror, a rearview camera display, or an area rearward of said vehicle.

12. The method of avoiding collisions of claim 10 further including determining driver's intended forward travel direction by determining said driver's head and eyes are facing a windshield of said vehicle in a visual zone other than said interior rearview mirror.

13. (canceled)

14. The method of avoiding collisions of claim 10 wherein the driver's head position is determined by identifying the driver's lips by one of the first and second cameras.

15. (canceled)

16. (canceled)

17. The method of avoiding collisions of claim 15 further including identifying said driver's eye focus by a position of the said driver's pupils relative to the sclera of said driver's eyes.

18. (canceled)
